(19) United States
(12) Patent Application Publication
(10) Pub. No.: US 2002/0073561 A1
(43) Pub. Date: Jun. 20, 2002

(54) Laser level

(76) Inventor: Ying Chou Liao, Ta-Li City (TW)

Correspondence Address: Hart, Baxley, Daniels & Holton, 59 John Street, Fifth Floor, New York, NY, 10038, US

(21) Appl. No.: 09/736,464

(22) Filed: Dec. 15, 2000

(51) Int. Cl. G01C 5/00; G01C 15/10

(52) U.S. Cl. 33/286; 33/285; 33/451; 33/DIG. 21

(57) ABSTRACT

A laser level includes a main frame having at least one monovial embedded in a surface of the main frame and a second frame is received in an end of the main frame. The second frame having a first tube for receiving a laser beam generating device therein, and a second tube for receiving a polariscope therein. A plurality of grooves are defined in an inner periphery of the second tube and a ridge extends from an outer periphery of the polariscope so that the ridge can be engaged with on of the grooves in the second tube to adjust the polariscope.

### FIELD OF THE INVENTION

The present invention relates to a laser level wherein an adjusting device is connected to the laser beam generating device to have an angle adjustment feature. A polariscope is removably located in front of the head of the laser beam generating device to let the laser beam be a straight line.

### BACKGROUND OF THE INVENTION

A conventional level generally includes a frame in which a plurality of horizontal gauges are engaged and each horizontal gauge has a monovial so as to check the level is located on a horizontal surface or not. In order to check the surface far away from the level, a laser beam generating device is attached to the level and a point is created by the laser beam to provide a reference point for the user. However, the conventional laser beam generating device can only provide one point and the user would prefer to have more than one point and to connect these points into a line so that the user can easily check the surface is horizontal or not. A polariscope is therefore connected to the level so that when the laser beam passes through the polariscope, a line can be marked on the surface. Nevertheless, the polariscope cannot adjusted and this limits the scope of use of the conventional level.

The present invention intends to provide a laser level having an angle adjustable laser generating device and polariscope so as to meet the various needs of the users.

### SUMMARY OF THE INVENTION

In accordance with one aspect of the present invention, there is provided a laser level and comprising a main frame having at least one monovial embedded in a surface of the main frame and a second frame received in an end of the main frame. The second frame has a first tube on one end of the second frame for receiving a laser beam generating device therein, and a second tube on the other end of the second frame for receiving a polariscope therein. The first tube and the second tube share a common axis. A plurality of grooves is defined in an inner periphery of the second tube. The polariscope has a ridge extending from an outer periphery of the polariscope and the ridge is engaged with on of the grooves in the second tube.

The primary object of the present invention is to provide a laser level having an adjustable laser beam generating device and polariscope.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is an exploded view to show a laser level of the present invention;

FIG. 2 is an exploded view to show a polariscope and the second tube of the second frame of the laser level of the present invention;

FIG. 3 is a side view to show the laser level of the present invention;

FIG. 4 shows two adjusting screws contacting the laser beam generating device;

FIG. 5 shows that the laser beam generating device is lowered by the two adjusting screws, and

FIG. 6 shows that the laser beam generating device is shifted to a side by the two adjusting screws.

### DETAILED DESCRIPTION OF THE PREFERRED EMBODIMENT

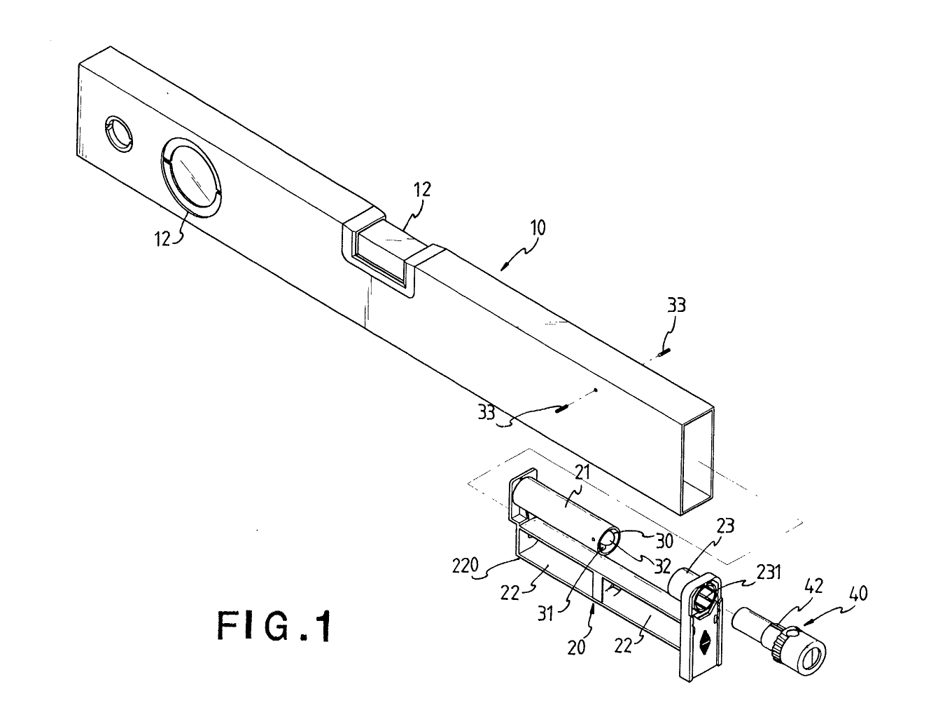

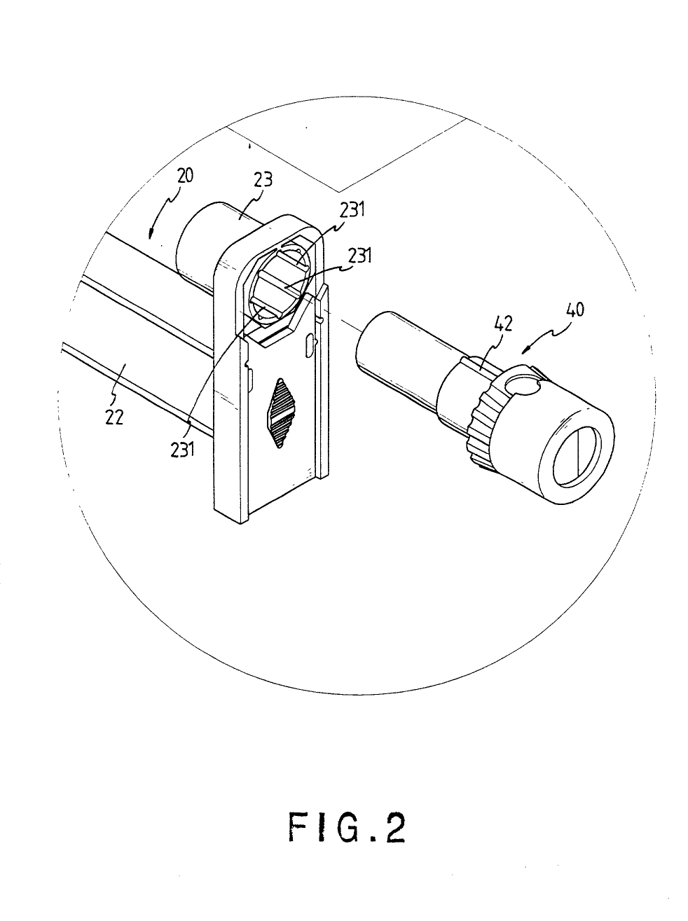

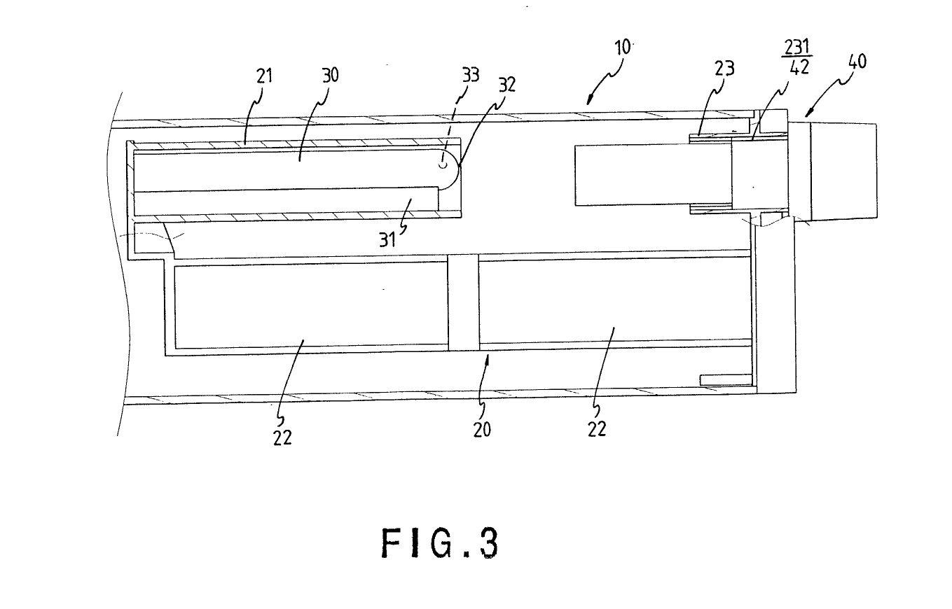

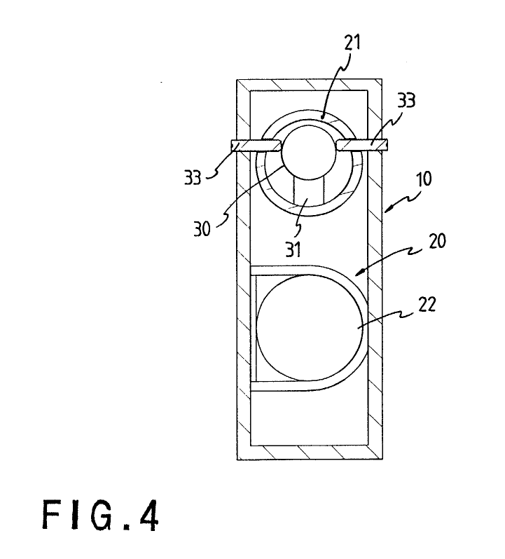

Referring to FIGS. 1 to 3, the laser level of the present invention comprises a main frame 10 having two monovials 12 embedded in two surfaces of the main frame 10 and a second frame 20 is received in an end of the main frame 10. The second frame 20 has two support plates extending from two ends thereof and a first tube 21 connected to one of the support plates on one end of the second frame 20 and a second tube 23 is connected to the other plate on the other end of the second frame 20. The first tube 21 and the second tube 23 share a common axis. A laser beam generating device 30 is received in the first tube 21 and faces the second tube 23. The laser beam generating device 30 has a spherical head 32 and a flexible member 31 made of rubber or foam material is received in the first tube 21 is connected to the laser beam generating device 30. Further referring to FIG. 4, two adjusting screws 33 extend through two opposite surfaces of the frame 10 and the first tube 21, and the two adjusting screws 33 contact the spherical head 32. A plurality of grooves 231 are defined in an inner periphery of the second tube 23.

A polariscope 40 is removably received in the second tube 23 and has a ridge 42 extending from an outer periphery of the polariscope 40. The ridge 42 is engaged with on of the grooves 231 in the second tube 23 so that the polariscope 40 can be positioned at different angle positions.

A lower support plate 220 is connected to the second frame 20 and two battery chambers 22 are defined between the lower support plate 220 and the second frame 20 so as to receive batteries therein to provide power to the laser beam generating device 40.

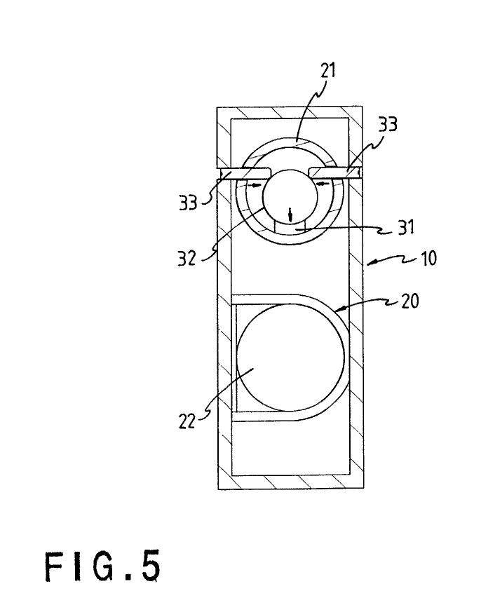

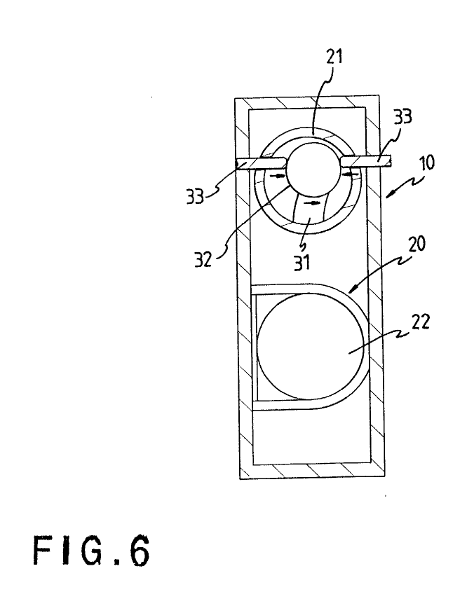

FIG. 5 shows that when screwing the two adjusting screws 33 toward to each other, the spherical head 32 is pushed to be lowered. As shown in FIG. 6, when the two adjusting screws 33 are screwed toward the same direction, the spherical head 32 is shifted to a side. By the adjustable laser beam generating device 30 and the polariscope 40, the level of the present invention can be used in different situations.

While we have shown and described various embodiments in accordance with the present invention, it should be clear to those skilled in the art that further embodiments may be made without departing from the scope and spirit of the present invention.

What is claimed is:

1. A laser level comprising:
a main frame having at least one monovial embedded in a surface of said main frame and a second frame received in an end of said main frame, said second frame having a first tube on one end of said second frame and a second tube on the other end of said second frame, said first tube and said second tube sharing a common axis, a laser beam generating device received in said first tube and facing said second tube, a plurality of grooves defined in an inner periphery of said second tube, and
a polariscope removably received in said second tube and having a ridge extending from an outer periphery of said polariscope, said ridge engaged with on of said grooves in said second tube.

2. The level as claimed in claim 1, wherein said laser beam generating device has a spherical head and a flexible member received in said first tube is connected to said laser beam generating device, two adjusting screws extend through two opposite surfaces of said frame and said first tube, said adjusting screws contacting said spherical head.

3. The level as claimed in claim 1, wherein said flexible member is made of rubber.

4. The level as claimed in claim 1 further comprising a lower support plate connected to said second frame and two battery chambers defined between said lower support plate and said second frame.
